(19) United States
(12) Patent Application Publication
(10) Pub. No.: US 2009/0026737 A1
(43) Pub. Date: Jan. 29, 2009

(54) Heavy duty lock hinge gate

(75) Inventor: Vincent Lee Webb, Merlin, OR (US)

Correspondence Address: Vince Webb, P.O. Box 116, 3153 Galice Road, Merlin, OR, 97532, US

(73) Assignee: TrailerWorks International LLC, Westlake Village, CA (US)

(21) Appl. No.: 12/007,833

(22) Filed: Jan. 16, 2008

Related U.S. Application Data
(60) Provisional application No. 60/880,426, filed on Jan. 16, 2007.

(51) Int. Cl. B62B 1/00; E05D 11/10; B62D 25/00

(52) U.S. Cl. 280/656; 16/319; 296/50

(57) ABSTRACT

A utility trailer is provided with repositionable fore and aft end gates. The fore and aft end gates each having a leg and a support member and are affixed to a lock hinge mechanism. The lock hinge mechanism includes a receiver coupled to the trailer bed, the receiver having a partially enclosed cavity that receives at least a portion of the respective gate leg, the cavity having an exposed, open front face adjacent at least one end of the cavity. An elongated slot is provided on one of the receiver and the respective gate leg. A receiver pin is received through the elongated slot and coupled to the respective gate leg and the receiver to allow constrained linear movement of the respective end gate while within the receiver cavity, and pivotal rotation of the respective end gate when extended to the exposed, open front face of the receiver insert cavity. The gate is positionable in a first substantially upright load-bearing position oriented along a first direction in which the gate leg is substantially received within the receiver cavity, and repositionable to an extended, substantially horizontal load-bearing second position oriented along an intersecting second direction in which the leg support member abuts a portion of the trailer bed frame. The receiver may include a removable receiver insert so that the end gates can be fully removed from the trailer, if necessary.

### CROSS-REFERENCE TO RELATED APPLICATIONS

This non-provisional application claims the benefit of U.S. Provisional Application No. 60/880,426, filed Jan. 16, 2007.

### BACKGROUND

The invention relates to a heavy duty lock hinge mechanism for a gate that enables quick and easy positioning of the gate between two different load-bearing positions. When used in conjunction with an end gate of a utility trailer, the hinge can extend the load-bearing surface of the trailer to accommodate longer loads positioned either fore or aft of a main trailer bed.

Various models and styles of utility trailers are known and used to haul various loads, such as lawn equipment, ATVs, motorcycles, furniture, appliances, trash, leaves, etc. Oftentimes, utility trailers have a fixed capacity, such as an open or closed 4′×6′ or 4′×8′ bed. However, it is desirable to accommodate different cargo sizes.

Several known trailers are manufactured with repositionable end gates on the fore or aft ends of the trailer. Examples include U.S. Pat. No. 6,378,893 to Jager and U.S. Pat. No. 5,544,944 to Keech. However, these designs suffer from various problems, such as difficulty in usage, awkward adjustability, lack of suitable load-bearing support, and/or potential for falling off during use if not secured properly. This latter problem could be potentially dangerous if the end gate becomes dislodged and falls off while the trailer is in motion.

### SUMMARY

There is thus a need for an improved mechanism for positioning of an end gate between multiple positions, such as vertical and horizontal positions.

In accordance with aspects of the invention, a lock hinge mechanism provides locking adjustment of an end gate between two positions. In an exemplary embodiment, the positions may include at least a substantially horizontal position and a substantially vertical position.

In accordance with additional aspects of the invention, the lock hinge mechanism may be load-bearing in either of at least two positions. In an exemplary embodiment, the end gate may reside in a vertical cavity of a receiver to lock the gate in an upright position and resist horizontal loading. The end gate may include a support member that rests upon a portion of the trailer bed frame to support vertical loading applied to the end gate in an extended, horizontal position.

In accordance with additional aspects of the invention, the lock hinge mechanism may be integrated into the trailer and does not require removal of the end gate to achieve repositioning. In an exemplary embodiment, the mechanisms may include an elongated guide slot and receiver pin to allow repositioning of the gate.

In accordance with further aspects of the invention, the lock hinge mechanism may be removably attached to a trailer assembly, so as to provide a removable end gate. In an exemplary embodiment, this may be achieved by a removable receiver insert coupled to the trailer by suitable fasteners.

In accordance with another aspect of the invention, the lock hinge mechanism may achieve positioning with simple, low effort movements by the user. For example, positioning from an upright position can be achieved by slight upward lifting of the end gate, followed by tilting of the end gate to an extended, substantially horizontal position. Positioning from the extended position can be achieved, for example, by pivoting upward of the end gate to a substantially vertical position, upon which the end gate will drop downward by gravity to its locked upright position.

In accordance with even further aspects of the invention, the end gate may be fixedly mounted into the lock hinge mechanism.

In various embodiments, a latch or other lock may be added to assist retention of the end gate in a desired position.

The above and other advantages may be achieved by various embodiments of the invention.

In accordance with an aspect of the invention, a repositionable gate and lock hinge assembly is provided that may be mountable to a receiver cavity of a vehicle. The assembly includes a gate having at least one leg, and a lock hinge mechanism coupled to the at least one leg. The lock hinge mechanism includes: a receiver insert sized to be received within a receiver cavity of a vehicle, the receiver insert defining a partially enclosed cavity that receives at least a portion of the gate leg, and an exposed, open front face adjacent at least one end of the cavity; an elongated slot provided on one of the receiver insert and the gate leg; and a receiver pin received through the elongated slot and coupled to the gate leg and the receiver insert to allow constrained linear movement of the gate while within the receiver cavity, and pivotal rotation of the gate when extended to the exposed, open front face of the receiver insert cavity. The gate may be positionable in a first position oriented along a first direction in which the gate leg is substantially received within the receiver insert cavity, and repositionable to a second position oriented along an intersecting second direction.

In accordance with another aspect, a trailer, such as a utility trailer, is provided with removable and repositionable fore and aft end gates. The trailer includes: a trailer bed frame coupled to a wheeled axle assembly; a tongue coupled to the trailer; a hitch coupled to the tongue; fore and aft end gates, each having at least two legs and a support member; and a lock hinge mechanism for each leg. The lock hinge mechanism includes: a receiver coupled to the trailer bed, the receiver having a partially enclosed cavity that receives at least a portion of the respective gate leg, the cavity having an exposed, open front face adjacent at least one end of the cavity; an elongated slot provided on one of the receiver and the respective gate leg; and a receiver pin received through the elongated slot and coupled to the respective gate leg and the receiver to allow constrained linear movement of the respective end gate while within the receiver cavity, and pivotal rotation of the respective end gate when extended to the exposed, open front face of the receiver insert cavity. The gate is positionable in a first substantially upright load-bearing position oriented along a first direction in which the gate leg is substantially received within the receiver cavity, and repositionable to an extended, substantially horizontal load-bearing second position oriented along an intersecting second direction in which the leg support member abuts a portion of the trailer bed frame.

### BRIEF DESCRIPTION OF THE DRAWINGS

Further aspects of the invention will be described with reference to the following drawings, wherein:

FIG. 1 illustrates a perspective view of an exemplary utility trailer having fore and aft end gates incorporating a heavy duty locking hinge mechanism in upright positions;

FIG. 2 illustrates the utility trailer of FIG. 1 in a second configuration in which the aft end gate is lowered to a horizontal position;

FIG. 3 illustrates the utility trailer of FIG. 1 in a third configuration in which the fore end gate is lowered to a horizontal position;

FIG. 4 illustrates an exploded perspective view of the trailer of FIG. 1;

FIG. 5 illustrates a partial close-up perspective view of exemplary receiver components of an exemplary lock hinge mechanism;

FIG. 6 illustrates a partial close-up perspective view of additional components of the lock hinge mechanism that interact with the receiver components of FIG. 5;

FIG. 7 illustrates a partial close-up perspective view of a complete heavy duty lock hinge mechanism mounted on an end gate with the end gate in a substantially horizontal position and retained by a lock mechanism;

FIG. 8 illustrates a top view of FIG. 7; and

FIG. 9 illustrates a partial close-up perspective view of a complete heavy duty lock hinge mechanism mounted on an end gate with the end gate in a substantially vertical position and retained by a second lock mechanism.

### DETAILED DESCRIPTION OF EMBODIMENTS

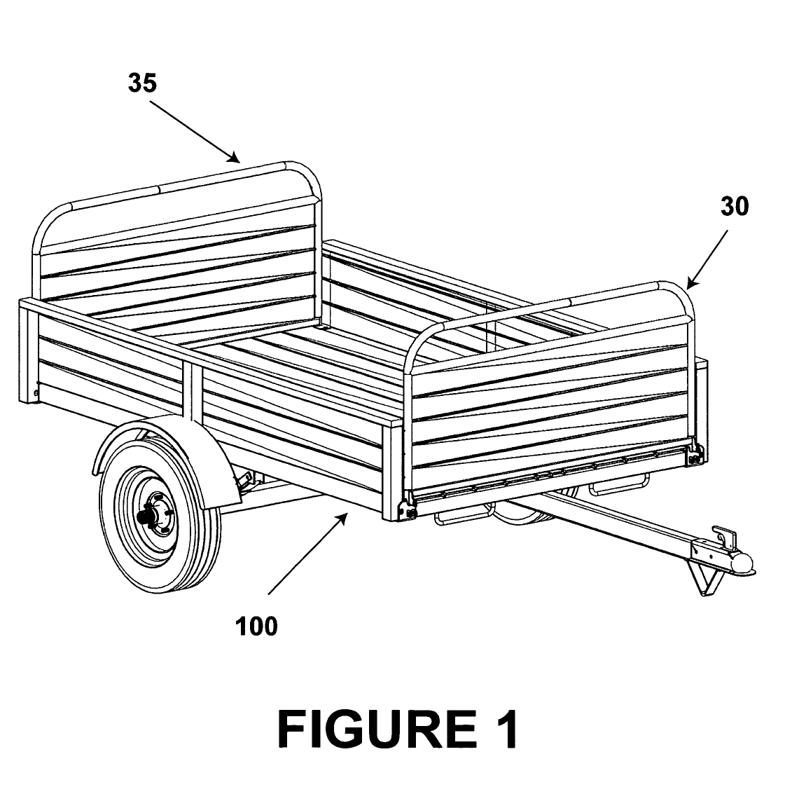

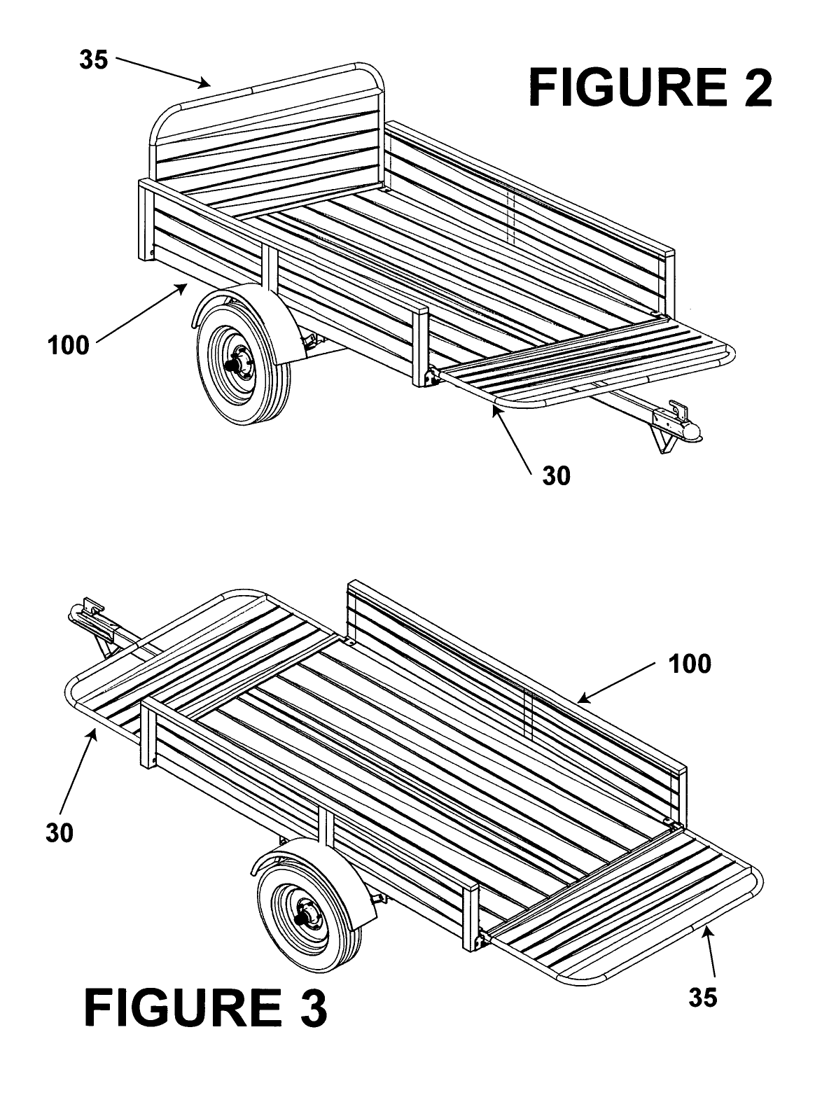

An embodiment of a utility trailer 100 having at least one, and preferably, two repositionable end gates is shown in FIGS. 1-4. End gates 30, 35 may be positioned between multiple positions, such as the upright position (FIGS. 1-2) and horizontally extended position (FIGS. 2-3) shown. In either position, the end gates 30, 35 may be load-bearing.

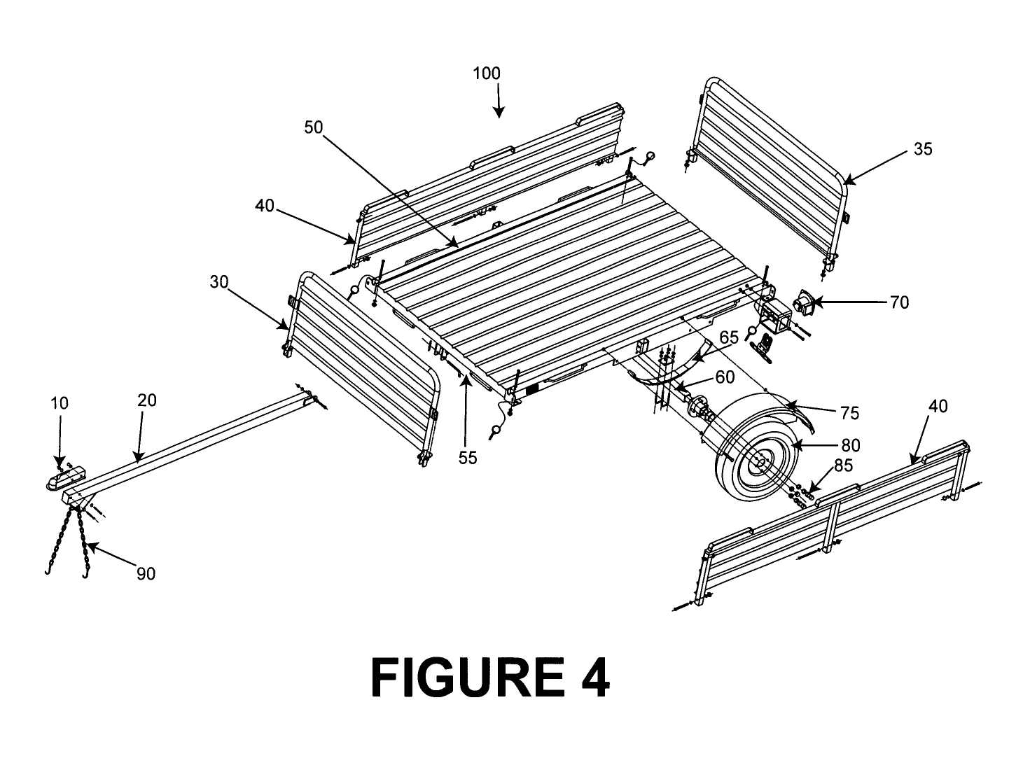

FIG. 4 shows an exploded perspective view of the exemplary utility trailer 100 of FIG. 1. Trailer 100 includes a coupler 10 attached to tongue 20. Coupler 10 typically will include safety chains 90. Tongue 20 is attached to a trailer bed frame 50 that is mated to an axle 60 through a pair of leaf springs 65. Axle 60 includes a pair of wheels 80 connected by lug nuts 85. Each wheel 80 may be covered by a fender 75. Optional side panels 40 can be removably or fixedly provided on bed 50 as known in the art. These side panels 40 can take various forms, such as solid panels, an external frame with a mesh, grid or other interior structure, a fence-type appearance, or other form, and can be made of various materials, such as steel, aluminum or wood.

Bed 50 may be fixed or tiltably coupled to tongue 20 to allow for ease in loading or unloading of cargo. Bed 50 is suitably retained to tongue 20 for travel, such as by lock pin 55. A pair of tail lights 70 and other optional markers and/or lights may be provided on trailer 100 as also known in the art.

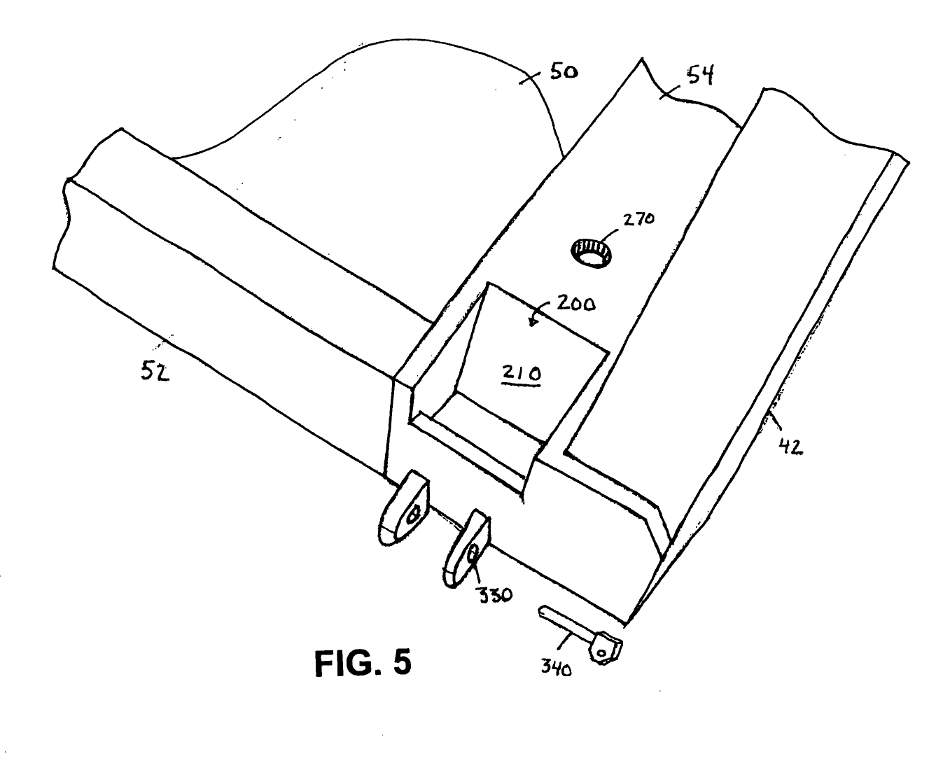

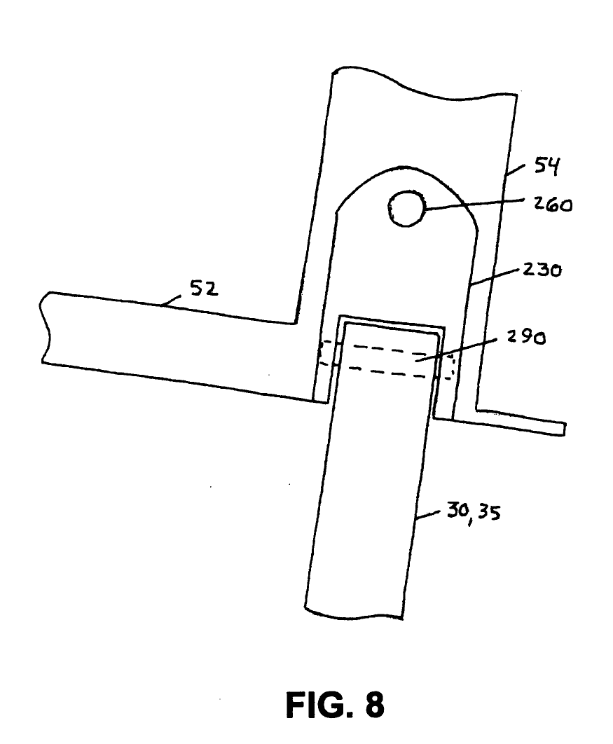

Fore and/or aft end gates 30, 35, respectively, can be mounted on ends of bed 50 and positionable between the upright and extended, horizontal positions shown in FIGS. 1-3. These end gates may be permanently attached to bed 50, but are preferably removably attached and readily repositionable through a lock hinge mechanism 200 that retains connection of the end gate 30, 35 with the trailer bed 50 during positioning. An exemplary embodiment of such a mechanism is shown in FIGS. 5-9.

In the partial view of FIG. 5, representing the right front and/or right rear of the trailer, bed frame 50 is shown to include a cross frame rail 52 and a longitudinal frame rail 54. A vertical leg 42 of side panel 40 is shown attached to frame rail 54. Within one of the frame rails, such as frame rail 54, are receiver components of a lock hinge mechanism 200 used to pivotally retain end gates 30, 35 thereon. Although this particular embodiment forms a removable lock hinge mechanism 200, this mechanism may be integrally formed into the bed frame 50.

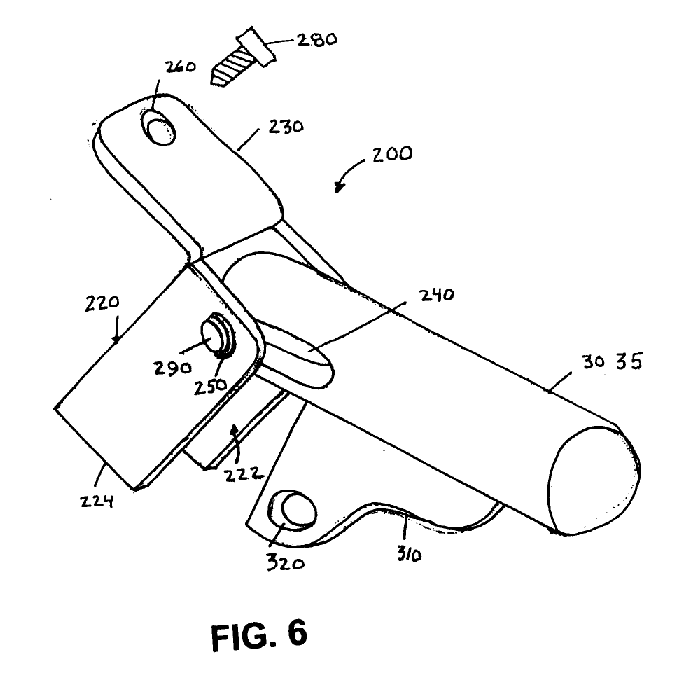

As shown in FIG. 5, receiver 210 includes a recessed vertical cavity within frame rail 54. In the embodiment shown, the receiver cavity 210 extends a predetermined depth within frame rail 54 to closely receive a portion of a leg of the end gate 30, 35 therein. To accommodate rotation of the leg, a front surface of receiver 210 may be partially open as shown. Receiver 210 may also receive a removable receiver insert 220, upon which is pivotally attached end gate 30, 35 (FIG. 6). Receiver insert 220 constrains movement of the end gate. An exemplary embodiment of insert 220 includes a base part 224, such as a U-shaped channel section, that is received within receiver cavity 210, a top connection part 230 that can be mated to a surface of frame rail 54, and an open front side portion 222 corresponding to the open portion near the front of receiver cavity 210 to accommodate pivoting action.

An exemplary mating uses fastener 280 inserted through opening 260 in the top connection part 230 and opening 270 in frame rail 54 to securely retain receiver insert 220 to the trailer 100. The receiver insert 220 allows for simpler initial assembly of the lock hinge mechanism 200 to the end gate 30, 35, quick removal of the lock hinge mechanism and end gate, if necessary, and an otherwise secure connection when in use.

Lock hinge mechanism 200 also includes an elongated slot 240 within the leg of end gate 30, 35 and a receiver pin 290 mounted through opposite openings 250 in receiver insert 220 and through elongated slot 240 (FIG. 6). Slot 240 is positioned near a distal end of the end gate 30, 35 with a predetermined slot profile such that when the end gate 30, 35 is substantially vertically oriented, the end gate 30, 35 is slidable downward into engagement with either a bottom of receiver cavity 210 or a bottom of receiver insert 220 to provide a load-bearing surface that will support the weight of the end gate. Moreover, the length of the leg extending beyond the slot 240 is sufficiently small such that when the leg is fully lifted or extended upward within receiver 210, the end gate 30, 35 is free to pivot as shown in FIG. 6.

Receiver pin 290 may be affixed by various fastening methods, such as friction fit, threads, clips, welding, bonding, crimping, etc. so that end gate 30, 35 can be securely affixed to or locked to receiver insert 220 to prevent inadvertent removal of the end gate 30, 35, even during positioning. However, because receiver insert 220 can be removed from frame rail 54 by removal of fastener 280, this provides for a simpler installation of the end gate 30, 35 to the lock hinge mechanism 200, and the ability to remove the end gate 30, entirely when not required for trailer use.

Alternatively, if a more secure attachment is desired, it is possible to permanently secure the receiver insert 220 into receiver cavity 210 once the end gate leg and receiver pin have been properly assembled. One suitable securement method would be by welding of receiver insert 220 inside receiver cavity 210. It is also possible to provide the openings 250 directly within the frame rail 54 in receiver cavity 210 so that receiver pin 290 attaches end gate 30, 35 directly to receiver cavity 210. In this case, receiver insert 220 would not be necessary.

As best shown in FIG. 6, end gates 30, 35 may also include a load-bearing support structure 310 mounted to the end gate 30, 35. Support structure 310 is located on end gates 30, 35 to mate against part of bed frame 50 or other fixed feature of trailer 100 when the end gate is repositioned to lie in the extended horizontal position. This enables the end gate 30, 35 to support the weight of the end gate, and external cargo load positioned on the end gate 30, 35. Preferably, support structure 310 is provided near both ends of end gate 30, 35 to increase stability when extended.

In the illustrated embodiment, support structure 310 may include an opening 320 through which a lock pin 340 may be received. To better secure the end gate in the extended, horizontal position, bed frame 50 may include at least one, and preferably two, projecting support bars 330, each being provided to one side of support structure 310. Support bars 330 may similarly include openings through which lock pin 340 can be received. This securely locks the position of the end gate 30, 35 in the extended, horizontal position.

Although shown with one support structure 310 on the end gate and two support bars 330 on the bed frame 50, this could be reversed. Alternatively, only one support bar 330 may be provided.

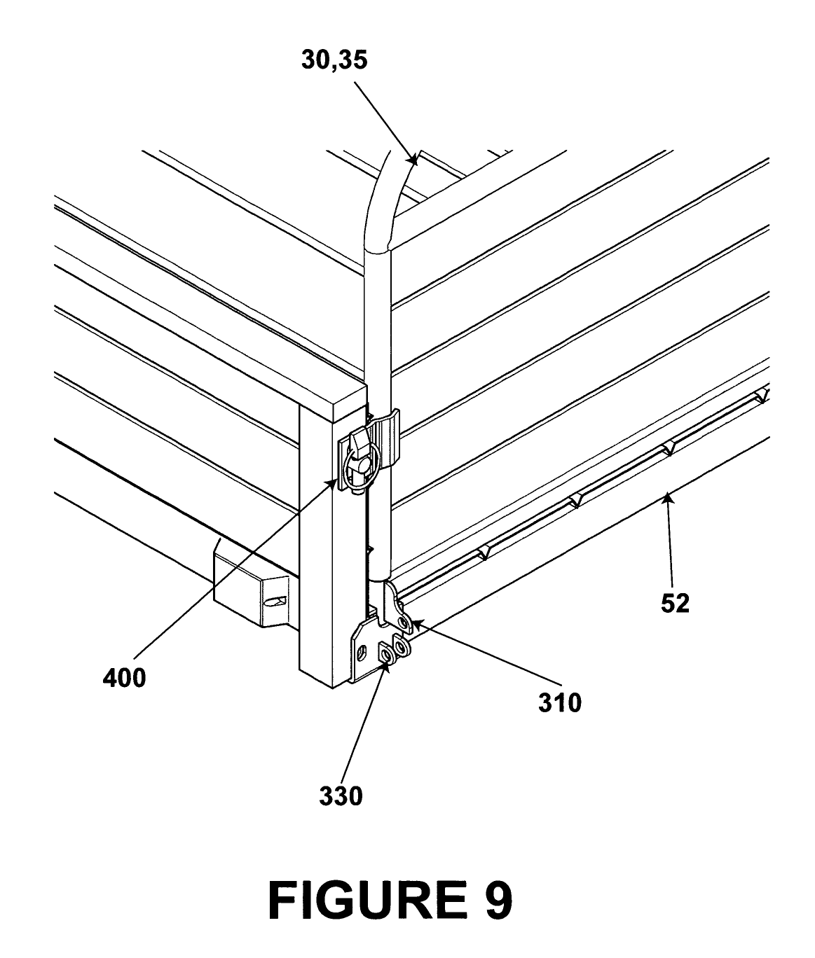

Additional securement can also be provided for the upright position. For example, as shown in FIG. 9, a lock mechanism 400 main retain end gates 30, 35 in position. This may include, for example, a mating connector on each of the end gate 30, 35 and trailer frame 50 or side fail 40 coupled by a lock pin or latch.

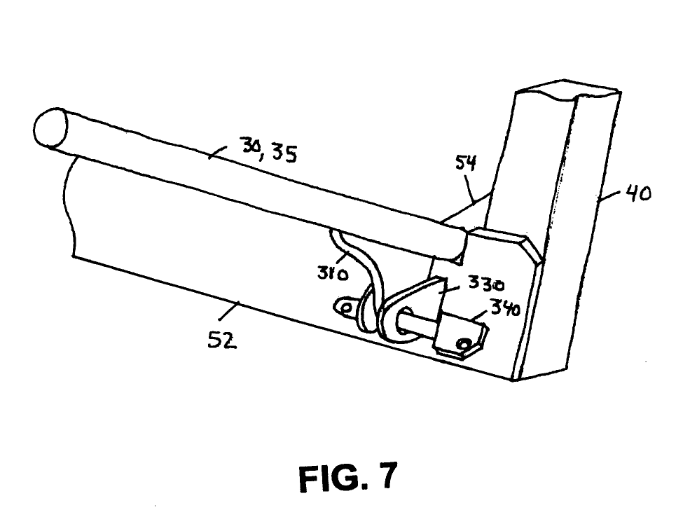

A utility trailer or other vehicle having such hinged end gates is capable of quick and easy reconfiguration through simple operations and easily performed by a single user. For example, from the upright position shown in FIGS. 1 and 9, movement to the extended horizontal position shown in FIG. 2, 3, 7 or 8 can be achieved by simply lifting up of the end gate 30, 35 until the base of the end gate reach the exposed front surface of receiver 210. Then, the end gate 30, 35 is simply pivoted to the extended position. This movement is initially constrained by the receiver cavity 210 and elongated slot 240 to vertical movement only, preventing rotation. When the end of slot 240 is near or reached, no further upward movement is possible. However, by the time this height is reached, the exposed or open front of receiver insert 220 and receiver cavity 210 allows the end gate 30, 35 to freely pivot about receiver pin 290 to a substantially horizontal position. Thus, when the end gate is fully retracted within receiver cavity 210 in the upright position, the receiver cavity and receiver insert substantially limit movement of the end gate to linear vertical movement. However, once sufficient height is achieved, the far end of the leg of end gate 30, 35 can rotate about the back wall of receiver insert 220 and the front side of the end gate is able to extend and pivot within the front exposed side of receiver insert 220 and the upper front exposed side of receiver cavity 210. Pivoting movement is stopped when support structure 310 abuts frame rail 52, as best shown in FIG. 7.

From the extended, horizontal position shown in FIGS. 2-3, 7 and 8, movement to the upright position is simply achieved by lifting the end gate through pivotal movement to an upright position, at which time gravity will automatically retract the legs of end gate 30, 35 downward fully into cavity 210 until contact is made with either the bottom of the receiver 210, receiver insert 220 or the end of elongated slot 240. This thus returns the end gate 30, 35 to the position shown in FIGS. 1 and 9.

It should be recognized that at all times during positioning and during use, the end gate 30, 35 is securely coupled to trailer 100 through the lock hinge mechanism 200. That is, pin 290 reliably retains and constrains movement of the end gate so that the user does not have to independently hold, support and position the end gate during the repositioning. Moreover, because the connection can be more secure and permanent, it is less likely that the end gate will become dislodged and fall off during use.

Moreover, the lock hinge 200 and associated support structure enable the end gates 30, 35 to be load-bearing in both upright and horizontal positions of the end gates.

Although shown with respect to end gates for a utility trailer, the heavy duty lock hinge mechanism 200 can be used with other gate structures, such as side panels 40, gates on full size trailers, or other vehicles, such as a pickup, truck or van.

Those skilled in the art will recognize that certain variations and/or additions can be made in these illustrative embodiments. It is apparent that various alternatives and modifications to the embodiments can be made thereto. It is, therefore, the intention in the appended claims to cover all such modifications and alternatives as may fall within the scope of the invention.

What is claimed is:

1. A trailer with a repositionable gate, comprising:
a trailer bed frame coupled to a wheeled axle assembly;
a tongue coupled to the trailer;
a hitch coupled to the tongue;
at least one gate having a leg; and
a lock hinge mechanism, the lock hinge mechanism including:
at least one receiver coupled to the trailer bed, the receiver having a partially enclosed cavity that receives at least a portion of the gate leg, the cavity having an exposed, open front face adjacent at least one end of the cavity;
an elongated slot provided on one of the receiver and the gate leg; and
a receiver pin received through the elongated slot and coupled to the gate leg and the receiver to allow constrained linear movement of the gate while within the receiver cavity, and pivotal rotation of the gate when extended to the exposed, open front face of the receiver insert cavity,
wherein the gate is positionable in a first position oriented along a first direction in which the gate leg is substantially received within the receiver cavity, and repositionable to a second position oriented along an intersecting second direction, the receiver cavity and elongated slot.

2. The trailer according to claim 1, wherein the elongated slot is provided on the gate leg.

3. The trailer according to claim 1, wherein the receiver cavity is vertically oriented.

4. The trailer according to claim 1, further comprising a receiver insert coupled to and received within the receiver cavity, the receiver insert receiving the receiver pin.

5. The trailer according to claim 4, wherein the receiver insert is removably coupled to the receiver to enable removal of the gate from the trailer.

6. The trailer according to claim 4, wherein the receiver insert includes a base having an opening that receives the receiver pin and an open front side portion that enables pivoting of the gate to the second position.

7. The trailer according to claim 1, wherein the first position is a substantially upright position and the second position is a substantially horizontal position.

8. The trailer according to claim 1, wherein the first position is a load-bearing position that constrains the gate and resists forces applied perpendicular to the first direction.

9. The trailer according to claim 8, wherein the gate includes a support structure abuttable with a portion of the trailer bed frame when the gate is at the second position so that the second position is also load-bearing position that constrains the gate and resists forces applied perpendicular to the second direction.

10. The trailer according to claim 9, wherein a lock assembly releasably locks the gate in the second position.

11. The trailer according to claim 1, wherein a lock assembly releasably locks the gate in the first position.

12. The trailer according to claim 1, wherein the gate is at least one of a fore end gate and an aft end gate of the trailer.

13. A repositionable gate and lock hinge assembly mountable to a receiver cavity of a vehicle, comprising:
a gate having at least one leg; and
a lock hinge mechanism coupled to the at least one leg, the lock hinge mechanism including:
a receiver insert sized to be received within a receiver cavity of a vehicle, the receiver insert defining a partially enclosed cavity that receives at least a portion of the gate leg, and an exposed, open front face adjacent at least one end of the cavity;
an elongated slot provided on one of the receiver insert and the gate leg; and
a receiver pin received through the elongated slot and coupled to the gate leg and the receiver insert to allow constrained linear movement of the gate while within the receiver cavity, and pivotal rotation of the gate when extended to the exposed, open front face of the receiver insert cavity,
wherein the gate is positionable in a first position oriented along a first direction in which the gate leg is substantially received within the receiver insert cavity, and repositionable to a second position oriented along an intersecting second direction.

14. The gate and lock hinge assembly according to claim 13, wherein the gate includes the elongated slot and the receiver insert includes a hole that fixedly receives the receiver pin.

15. The gate and lock hinge assembly according to claim 13, further comprising a fastener that mounts the receiver insert to the vehicle receiver.

16. The gate and lock hinge assembly according to claim 15, wherein the fastener is removable to allow attachment and removal of the end gate and hinge assembly from the vehicle.

17. The gate and lock hinge assembly according to claim 13, further comprising a support member affixed to the gate leg shaped to abut against the frame of the vehicle when the gate is in the second position so that the second position is load-bearing.

18. The gate and lock hinge assembly according to claim 13, wherein the first position is a load-bearing position that constrains the gate and resists forces applied perpendicular to the first direction.

19. The gate and lock hinge assembly according to claim 13, further comprising a lock assembly that locks the gate in at least one of the two positions.

20. A trailer with removable and repositionable fore and aft end gates, comprising:
a trailer bed frame coupled to a wheeled axle assembly;
a tongue coupled to the trailer;
a hitch coupled to the tongue;
fore and aft end gates, each having at least two legs and a support member; and
a lock hinge mechanism for each leg, the lock hinge mechanism including:
a receiver coupled to the trailer bed, the receiver having a partially enclosed cavity that receives at least a portion of the respective gate leg, the cavity having an exposed, open front face adjacent at least one end of the cavity;
an elongated slot provided on one of the receiver and the respective gate leg; and
a receiver pin received through the elongated slot and coupled to the respective gate leg and the receiver to allow constrained linear movement of the respective end gate while within the receiver cavity, and pivotal rotation of the respective end gate when extended to the exposed, open front face of the receiver insert cavity, wherein
the gate is positionable in a first substantially upright load-bearing position oriented along a first direction in which the gate leg is substantially received within the receiver cavity, and repositionable to an extended, substantially horizontal load-bearing second position oriented along an intersecting second direction in which the leg support member abuts a portion of the trailer bed frame.
